(19) United States
(12) Patent Application Publication
(10) Pub. No.: US 2010/0141655 A1
(43) Pub. Date: Jun. 10, 2010

(54) Method and System for Navigation of Audio and Video Files

(76) Inventors: Eran Belinsky, Haifa (IL); Elad Shahar, Rehovot (IL)

Correspondence Address: IBM CORPORATION, T.J. WATSON RESEARCH CENTER, P.O. BOX 218, YORKTOWN HEIGHTS, NY, 10598, US

(21) Appl. No.: 12/329,653

(22) Filed: Dec. 8, 2008

(51) Int. Cl. G06T 11/20; G06T 11/00

(52) U.S. Cl. 345/440; 345/467

(57) ABSTRACT

A method and system for navigation of an audio or a video file are provided. The method includes providing an audio or video file and generating text associated with the file. This may include one or more of: transcripts of audio content, extraction of text from video content, associating text with the audio or video content, including user tagging of the file. A plurality of phrases from the text for the file are displayed in a phrase cloud, with emphasis of a displayed phrase to indicate the relevance of the phrase in a predefined section of the file. The phrase cloud is animated to show changes in the emphasizing during progression through the file.

### CROSS-REFERENCE TO RELATED APPLICATIONS

The present application is related to the following application with a common assignee, U.S. patent application Ser. No. 11/688,272 (Attorney Docket No. IL9-2006-0103US1) filed Mar. 20, 2007 entitled “Method and System for Navigation of Text”.

### FIELD OF THE INVENTION

This invention relates to the field of navigation of computer files. In particular, this invention relates to navigation of audio and video files.

### BACKGROUND OF THE INVENTION

Navigation of audio and video files is problematic because it is difficult to get an overview or outline of such files.

In the case of video files, one can rely on vision and quickly browse a video file by moving a gauge forward. There are known tools that detect scene transitions in a video file and can present a picture from every scene, but this also only provides a limited set of navigation cues. Problems also arise in cases where there is a very low number of scenes and therefore visual content is limited, for example, recorded lectures.

In the case of audio files, there are known tools that create a transcript and let a user browse it and click on a phrase and cause the audio/video file to jump to that location, but these tools do not provide a quick navigation or skimming capability.

U.S. patent application Ser. No. 11/688,272 filed Mar. 20, 2007 entitled “Method and System for Navigation of Text” discloses a method and system for fast navigation or skimming over linear text. The described method and system provide a means for presentation and animation of tag or phrase clouds for navigation of linear text.

This addresses the finding that most people find that navigating a book or a long text in paper form is more pleasing than reading these in electronic form on screen. One reason for this is that skimming a real book is easier since it is possible to jump quickly back and forward and to flip through a series of pages, with fine control over the speed with which the pages are flipped.

U.S. patent application Ser. No. 11/688,272 discloses the use of a phrase cloud (also known as a tag cloud or weighted list) to represent phrases from a linear text to enable skimming through the text using textual content cues from the phrase cloud.

Phrase clouds are known from web sites where they are used as a visual depiction of content tags. Tags are words or phrases and may be user generated or based on the word content of the web site. Often, more frequently used tags are depicted in a larger font or otherwise emphasized, while the displayed order is generally alphabetical.

### SUMMARY OF THE INVENTION

The present invention extends the use of phrase clouds to provide navigation through audio or video files.

According to a first aspect of the present invention there is provided a method for navigation of a file, comprising: providing an audio or video file; generating text associated with the file; displaying a plurality of phrases from the text for the file; emphasizing a displayed phrase to indicate the relevance of the phrase in a predefined section of the file; and animating the display of phrases to show changes in the emphasizing during progression through the file.

According to a second aspect of the present invention there is provided a system for navigation of an audio or a video file, comprising: a text generation tool associated with the file and extracting phrases from the text; a user interface including a display of a plurality of phrases representing the content of the text, and including means for progressing though the file to advance the display; means for emphasizing a displayed phrase to indicate the relevance of the phrase in a predefined section of the file; and an animator for animating the display of phrases to show changes in the emphasizing during progression through the file.

According to a third aspect of the present invention there is provided a computer software product for navigation of a file, the product comprising a computer-readable storage medium, storing a computer in which program comprising computer-executable instructions are stored, which instructions, when read executed by a computer, perform the following steps: providing an audio or video file; generating text associated with the file; displaying a plurality of phrases from the text for the file; emphasizing a displayed phrase to indicate the relevance of the phrase in a predefined section of the file; and animating the display of phrases to show changes in the emphasizing during progression through the file.

According to a fourth aspect of the present invention there is provided a method of providing a service to a customer over a network, the service comprising: providing an audio or video file; generating text associated with the file; displaying a plurality of phrases from the text for the file; emphasizing a displayed phrase to indicate the relevance of the phrase in a predefined section of the file; and animating the display of phrases to show changes in the emphasizing during progression through the file.

### BRIEF DESCRIPTION OF THE DRAWINGS

The subject matter regarded as the invention is particularly pointed out and distinctly claimed in the concluding portion of the specification. The invention, both as to organization and method of operation, together with objects, features, and advantages thereof, may best be understood by reference to the following detailed description when read with the accompanying drawings in which:

FIG. 1 is a block diagram of a system in accordance with the present invention;

FIG. 2 is a block diagram of a computer system in which the present invention may be implemented;

FIG. 3 is a schematic representation of an audio and a video file with text generation in accordance with an aspect of the present invention;

FIG. 4 is a representation of a graphical user interface in accordance with the present invention;

FIGS. 5A and 5B are flow diagrams showing methods of generating a phrase cloud in accordance with aspects of the present invention; and

FIG. 6 is a flow diagram showing a method of operation of the phrase cloud in accordance with an aspect of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numbers may be repeated among the figures to indicate corresponding or analogous features.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The described system uses phrase clouds to support navigation of audio and/or video files. Audio files may include content in the form of speech, music, drama, or any form of audio content which changes over time. Video files may include only visual content or a combination of visual and audio content.

Audio and video files can have text associated with the files and the text may be generated in a number of different possible ways. Text may be extracted from audio content by means of automatic speech recognition (ASR) or manual transcript of the audio content. Text may be extracted from video content where the video content includes written words. Text may also be associated with audio or video content in the form of descriptive or commentary text associated with the content, or metadata associated with the content. This may be associated with the content by the file creator or by a user, for example by user input tags which may be personal or collaborative.

This results in audio or video files with text associated with specific sections or locations of the audio or video file. The sections or locations of associated text can be specified by ranges of timestamps or specific timestamps.

Words or phrases within the associated text can be used for navigation within the audio or video file, letting users navigate to specific locations. The term phrase may be a single word or a combination of multiple words; it may also be a partial word or a combination of partial words. Phrases are represented in a phrase cloud which may be animated to show the frequency variation of phrases through the file. The navigation may be performed by selecting a phrase in the phrase cloud and viewing a timeline on which a frequency graph is provided showing the frequency of the phrase in the file. Clicking on a location on the graph navigates the file to that location. This provides a skimming capability for browsing the audio or video file, providing the user with an overview of the whole file and allowing navigation based on phrases of interest to the user.

In a pre-processing stage, phrase locations and frequencies are generated and associated with the audio or video file. This can be done using automatic speech recognition (ASR), or by user tagging of specific locations or sections with words, or by other text generation methods. The method and system of U.S. patent application Ser. No. 11/688,272 filed Mar. 20, 2007 entitled “Method and System for Navigation of Text” for fast navigation or skimming over linear text is adapted for navigation of the audio or video file.

In the context of navigation of text, a browsing unit is used as a unit of text which can be displayed on the electronic apparatus being used to view the text. A browsing unit is most commonly a page, although it may be a section, or paragraph, etc.

In the context of navigation of audio or video files, the files are usually played using a media player application as a continuous stream. There may be sections or breaks in the stream which provide navigational help, such as chapters, intervals, etc. For the purpose of the described method and system, the audio and video files may be divided into sections of a predetermined duration of time.

A tool for displaying or representing the audio or video file is provided, such as a media player application. The tool has control means to change the position of the playback of the audio or video file due to the navigation by the user. The described system works with this tool, or is embedded in it.

The main concept which helps skimming is that of animating, or “playing” a phrase cloud associated with the media player application. For the audio or video file, or a section of it, a set of words or phrases is collected and the degree to which sections of the audio or video file relate to that word or phrase is calculated. The cloud is then animated by changing the emphasis of the phrases according to the location in the playback of the audio or video file. The emphasis may be changed by visually highlighting a phrase using size, color, etc. The user can then detect sections or locations of the file where the phrases of interest are emphasized, and request to navigate to those sections or locations. The phrases in the cloud may remain in the same place in the entire playback, making it easy to quickly skim over the entire file. If the phrases in the cloud change between different portions of the file, the phrase position movement within the cloud is kept to a minimum.

The described method and system provide the user with an overview of how the topic focus varies across an entire audio or video file.

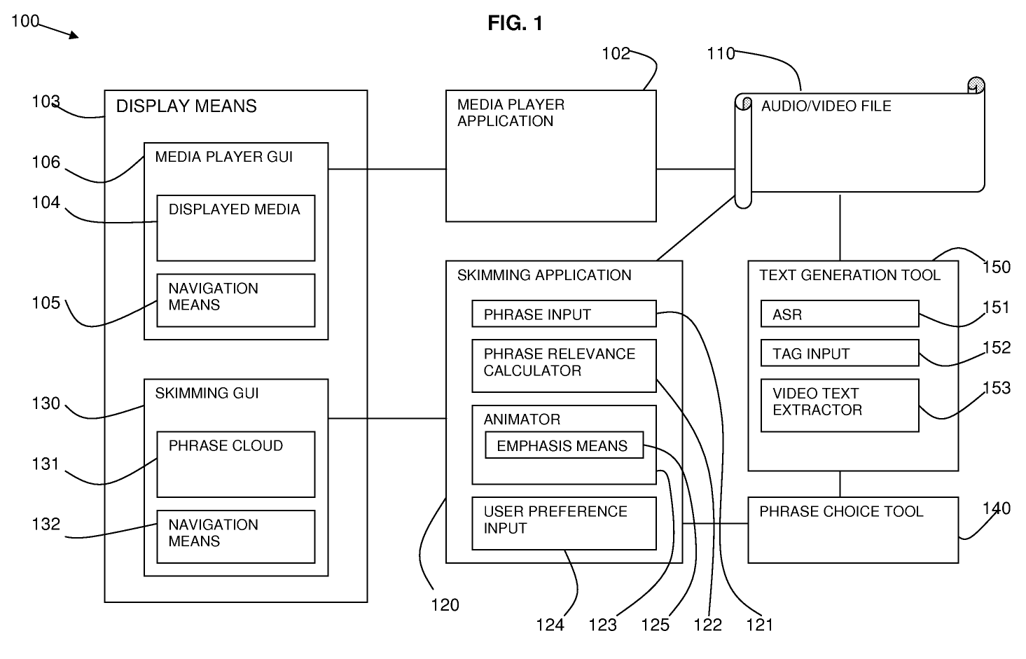

Referring to FIG. 1, a block diagram shows a system 100 with a media player application 102 for playing audio and/or video files 110.

The media player application 102 is coupled to a display means 103 and a media player graphical user interface (GUI) 106 shows displayed media 104 such as a video from a video file 110. In the case of an audio file 110 being played, if there is no associated video, media player applications 102 may display generated images such as patterns or leave the display blank. The media player GUI 106 includes navigation and control means 105 such as a scrollbar for moving through the file 110 and control buttons for play, pause, fast forward, stop, volume, etc.

A navigation or skimming application 120 is provided which may be provided integrally to the media player application 102 or as a separate application working in conjunction with the media player application 102. The skimming application 120 provides a skimming GUI 130 including a navigation means 132.

The skimming GUI 130 includes a window showing a representation of a phrase cloud 131 for text generated from the audio or video file 110. The window may also include a display of a portion of the audio or video file 110 which the phrase cloud 131 is referring to.

The system includes a text generation tool 150 for generating text associated with the audio or video file 110.

In one embodiment, the text generation tool 150 includes an automatic speech recognition (ASR) tool 151 which can generate an automatic text transcript of audio input. The text is provided with words having timestamps associated with the audio or video file 110. The text generation tool 150 may also include means for manual input of text transcript of audio or video files.

In another embodiment, the text generation tool 150 includes a tag input 152 for user input of textual tags associated with given locations or sections of the audio and video files.

In a further embodiment, the text generation tool 150 includes a video text extractor 153 for extracting text from a video file 110, for example, where text content is shown in the video.

The text generation tool 150 may include one or more of the above embodiments to associate text with the audio or video file 110 with the phrases from the text provided with a timestamp or timestamp range of where they appear in or are associated with the audio or video file 110. Phrases from the text may be associated with a portion of the audio or video file 110 between two timestamps.

The skimming application 120 includes a phrase input 121, a phrase relevance calculator 122, an animator 123 including an emphasis means 125, and a user preference input 124.

The skimming application 120 requires as an input 121 a list of phrases to be shown in the phrase cloud 131. This list can be generated using pre-existing methods with user guidance, in order to identify phrases of importance. There may be a phrase choice tool 140 which automatically, or semi-automatically with some input, selects phrases from the audio or video file 110.

The visualization/animation of the phrase cloud 131 is provided in the skimming GUI 130 which presents the phrases associated with the audio or video file 110 which are given as the input. The cloud may display the phrases in different forms, the most straightforward being in an alphabetical arrangement. The cloud is animated by emphasising the phrases as the audio or video file 110 is played. The phrases may be highlighted, for example by size or color, showing their frequency in sections of the audio or video file 110 and in neighbouring sections to create an animation. Each phrase may be in a fixed position within the phrases to provide a smooth animation.

The emphasis of a phrase such as its size or color may be a function of the number of occurrences in the current section and nearby sections of the audio or video file. For example, the larger the font or the stronger the color of a phrase, the more relevant it is to the current section or to a section which is nearby. The animation is provided by the change in emphasis as the phrase cloud is run through the file.

The user can navigate the skimming GUI 130 using the navigation means 132 to drag a scrollbar, or “play” the phrase cloud 131 to animate it. Using the navigation means 132 (e.g. cloud scrollbar, play, etc.) continuously changes the current section which is displayed in the phrase cloud 131. It should be noted that changing the current section which is displayed in the phrase cloud 131 of the skimming GUI 130 is separate from the navigational means 105 of the media player application 102.

The size of phrases is determined in a way that animates smoothly. Phrase sizes do not change abruptly and this makes the animation meaningful since the continuous animation allows the user to interpret the cloud animation of dragging through an accelerated play of the audio or video file 110. This also allows the user, who is viewing the phrase cloud, to determine that a phrase of medium emphasis indicates that it occurs nearby, and that it may be reached by dragging the scrollbar a little forward or backward, until the emphasis of the phrase in the cloud is high.

During animation of the phrase cloud 131 in the skimming GUI 130, the current displayed media 104 which is displayed by the media player application 102 may continue or be paused. However, when the phrase cloud 131 is not animated, the phrase cloud 131 which is displayed in the skimming GUI 130 would typically refer to the same place in the playback of the displayed media 104 of the media player application 102.

A typical scenario would be that the user drags the scrollbar of the skimming GUI 130 to find where phrases of interest become more emphasised, during this time the phrase cloud changes, but the displayed media 104 may pause or continue playing by the media player application 102. Eventually, the user stops dragging when he believes the position currently presented in the phrase cloud 131 may be of interest. At this point the playback in the media player application 102 is updated to show the position currently presented by the phrase cloud 131.

Smoothing the emphasis of phrases in phrase clouds addresses a problem of continuity. Phrase clouds assume text flow, and rely on this assumption to do smoothing, i.e. if a phrase appears in a nearby section, it will appear more emphasised than usual even though the current section does not contain the phrase. The idea is that even though the current section does not contain that phrase, the content of the current section is likely to be related due to text flow.

The list of phrases could be determined either in advance, or it could be dynamically constructed while displaying the animation. Dynamic construction may adapt to the personal preferences of the user, his context, previously used search queries, topics of personal interest, etc. The list could be constructed automatically, manually, or by a combination of automatic construction with user intervention.

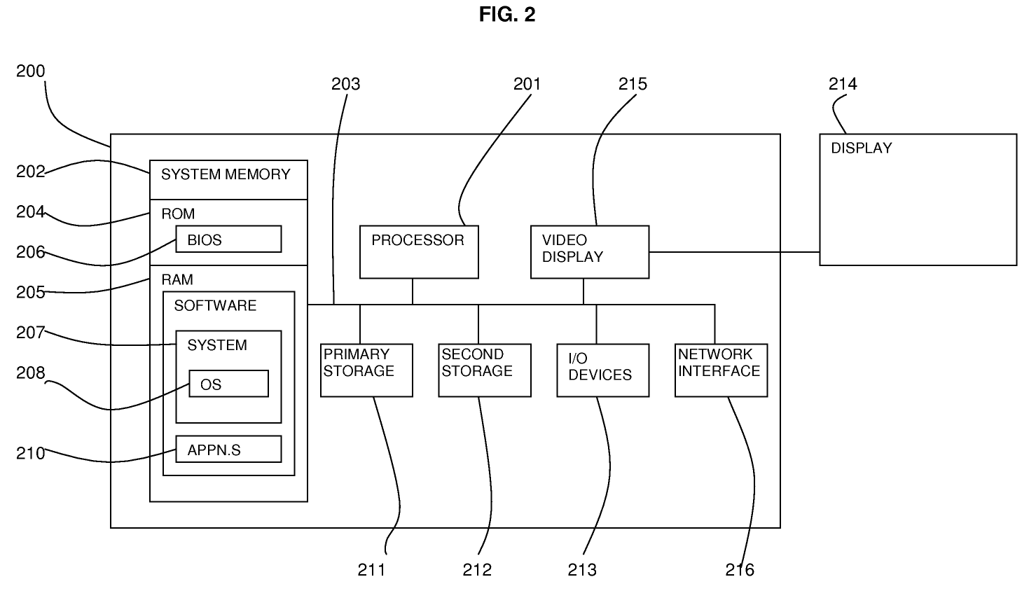

Referring to FIG. 2, an exemplary system in which the described system may be implemented is shown and includes a data processing system 200 suitable for storing and/or executing program code including at least one processor 201 coupled directly or indirectly to memory elements through a bus system 203. The memory elements can include local memory employed during actual execution of the program code, bulk storage, and cache memories which provide temporary storage of at least some program code in order to reduce the number of times code must be retrieved from bulk storage during execution.

The memory elements may include system memory 202 in the form of read only memory (ROM) 204 and random access memory (RAM) 205. A basic input/output system (BIOS) 206 may be stored in ROM 204. System software 207 may be stored in RAM 205 including operating system software 208. Software applications 210 may also be stored in RAM 205.

The system 200 may also include a primary storage means 211 such as a magnetic hard disk drive and secondary storage means 212 such as a magnetic disc drive and an optical disc drive. The drives and their associated computer-readable media provide non-volatile storage of computer-executable instructions, data structures, program modules and other data for the system 200. Software applications may be stored on the primary and secondary storage means 211, 212 as well as the system memory 202.

The computing system 200 may operate in a networked environment using logical connections to one or more remote computers via a network adapter 216.

Input/output devices 213 can be coupled to the system either directly or through intervening I/O controllers. A user may enter commands and information into the system 200 through input devices such as a keyboard, pointing device, or other input devices (for example, microphone, joy stick, game pad, satellite dish, scanner, or the like). Output devices may include speakers, printers, etc. A display device 214 is also connected to system bus 203 via an interface, such as video adapter 215.

Text Generation

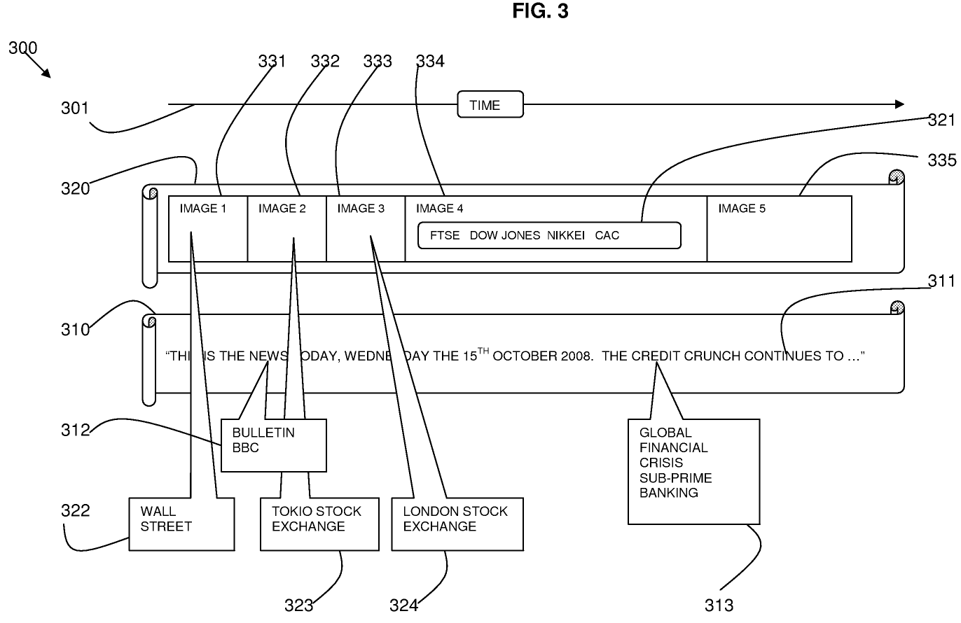

Referring to FIG. 3, a schematic diagram 300 shows the generation of text associated with audio and video files. The diagram 300 shows a video file 320 and an audio file 310 which run from left to right with an associated time line 301. The audio file 310 and video file 320 may be played separately, or together with a timestamp in the audio file 310 corresponding to a timestamp in the video file 320 or may be provided as a combined file. The video file 320 may be made up of frames 331-335 of images or units of video streams.

The audio file 310 may have a text transcript 311 provided either manually or using a ASR system. In either case, the words in the text transcript 311 have timestamps for the beginning of each word. When ASR processes an audio file (or a video file's audio track) it usually splits the preprocessed data into chunks that represent phonemes. It “knows” where a phoneme starts as the phoneme has a timestamp, so it uses this information to note when a word starts which indicates where it is located in the file.

The video file 320 may have text 321 in the file images. This text 321 can be identified and associated with a timestamp or a period between two timestamps at which it appears.

In addition or alternatively, the file creator or a user may insert tags 312, 313, 322-324 in the audio or video files 310, 320. The tags 312, 313, 322-324 have text content. When a user tags an audio or video file 310, 320 at a specific time during playing the file, the tag can be associated with that timestamp.

An implementation for generating the location and frequencies of text is described. A set is created that contains all the phrases that are extracted from the audio or video file using one or more of the mechanisms described. The phrases are also used as keys, so that every phrase points to a list that contains all the timestamps within the audio file when it occurred. The number of items in a phrase's list is the phrase's frequency. This covers the generation of the information for the whole file.

If a section of the audio or video file is considered that starts at time t1 and ends at time t2, a sub-set of the original set is created by scanning the original set, and collecting only those words which have occurrences that took place between t1 and t2 and save only these occurrences in a list, for every phrase.

Example of a User Interface

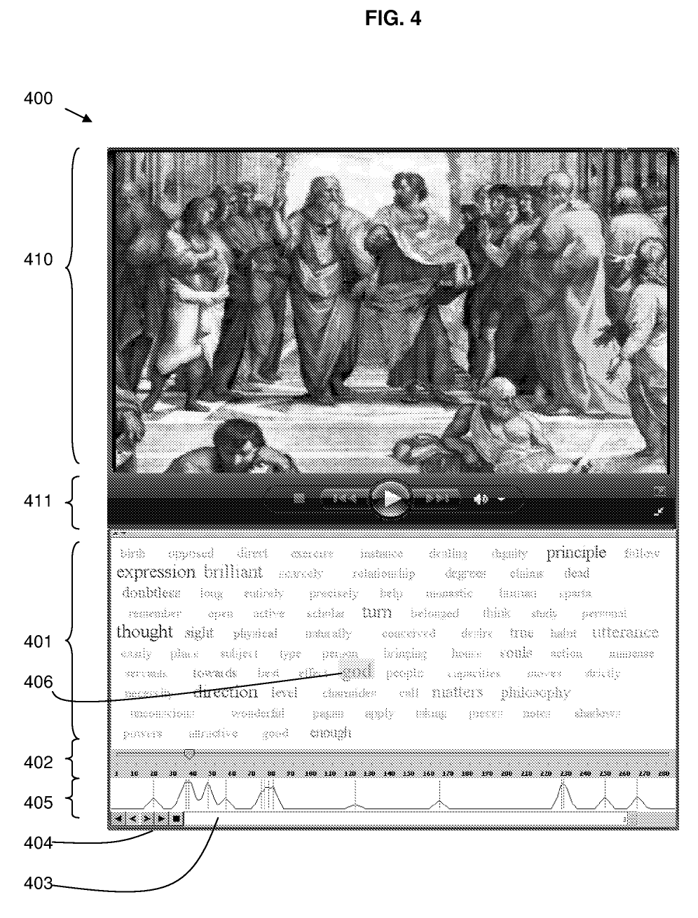

Referring to FIG. 4, a representation of a user interface display 400 for the skimming application is provided. The display 400 is in the form of a dialog window, a portion of which displays the phrase cloud 401. The dialog window also includes a display 410 of the playback position of the audio or video file to which the phrase cloud 401 refers. The display 410 has control buttons 411 for playback including a play/pause button, a frame forward button, a frame back button, a stop button, and a volume button. The display 410 may be the media player application's display or a separate display provided adjacent the phrase cloud in the skimming GUI.

In the display 400 a bar (or a slider) 402 is provided which shows the current location within the audio or video file. There is an input field 403 in which a user can input a number of seconds which indicates how long the animation of the entire file will take to play, if pressed. This allows the user to control the speed of the animation. There are also control buttons 404, including play/pause, stop, end, next page, previous page buttons 404 for operating the skimming display.

Running adjacent the bar 402 and aligned exactly to span the entire bar 402, a time-frequency graph 405 is provided which shows the frequency of a selected phrase 406 at times across the entire audio or video file. The user can click on a selected phrase 406 in the phrase cloud 401 and see its locations on the time-frequency graph 405. Clicking on an occurrence on the time-frequency graph 405 will navigate the audio or video file to the desired location.

The time-frequency graph 405 is smoothed, so that the actual appearance of a phrase is marked by a vertical line, while the trend line goes up and down more smoothly. The motivation for smoothing the time-frequency graph 405 is that obtaining an overview is achieved by animating the phrase cloud 401 (when the section progresses with time) and without smoothing, this animation will be jumpy and will not allow quick skimming of the file.

Pressing play in the control buttons 404 continuously changes the current file section which is displayed by the cloud 401. When pressing play in the buttons 404, the sizes of the phrases change according to the new file section. The location of the phrases do not change, and they are sorted, for example, alphabetically. When a phrase is emphasised, it means that it appears at or near the current section. The more emphasised the phrase, the closer the current section is to a section which refers to the phrase. The emphasis of the phrase is also affected by the number of occurrences of the phrase in the vicinity of the current section. The playing speed can be set by the user. Pressing the play button 404 does not change the display 410 of the playback of the audio or video file, it just animates the phrase cloud 401. When the animation is stopped by the user, the display 410 of the playback skips to the position of the phrase cloud 401.

The phrase cloud 401 can represent the whole file or a section of it (a fixed or varying length “time window”). Moving through the file moves the section along, thus changing the content of the phrase cloud 401 pane to reflect the current section. The user can define the desired section size, or set it to include the whole file (thus providing a list of keywords that help navigating the whole file).

In one embodiment, an additional feature could provide an indication of whether the score of a phrase grows or shrinks in previous or next sections. This could be done, for example, by vertically stretching or shrinking the beginning and end of the phrase, or by adding additional size-changing arrows on each side of the phrase.

In another embodiment, it may be that for a specific section, a phrase has a high score, but the phrase does not actually appear in that section, but in sections nearby. If the current section actually contains the phrase, the phrase will be presented differently in the cloud (e.g., a different color, or underline).

Clicking on a location in the bar 402 updates the phrase cloud 401, the display 410, and optionally the section displayed in the media player application. Dragging the bar 402 updates the phrase cloud 401 and optionally the playback display 410 continuously. Releasing the bar 402 also updates the playback display 410, and optionally the media player application to display the corresponding position.

Dragging a user's pointer device such as a mouse in the graph section 405 defines a section of the file to be animated. When the pointer device is released, the section is set, and is automatically animated. Pressing the play button 404 will present the animation limited to the same section. Clicking in the graph section 405 cancels the section definition. Thus, future clicking of play button 404 will again animate the entire file.

Actions on Phrases in the Cloud

There are many different ways to activate a user's pointer device, for example, a mouse-click (different buttons, double click, etc). In the following different kinds of activation are referred to as “click #n”.
Click #1 on a phrase in the cloud selects the phrase, and displays a graph in the graph window, which plots the score of that phrase over the entire file.
Click #2 on a phrase switches the viewer to the section where the phrase has the highest score.
Click #3 switches to a search results page of a browser application where the phrase serves as the query.
Hovering over a phrase shows an additional user interface for it, for example, as small arrow buttons before and after the phrase. Clicking on one of the arrows will jump the navigation to the next/previous local maximum for that phrase or to the next/previous occurrence.

When using any of the above methods for changing playback location, the phrase is highlighted in the viewer.

Changing the List of Phrases in the Cloud

The set of phrases which are shown in the cloud may be the same for all sections of the file, or it may be that after some sections a phrase is removed and replaced by another phrase. The user can change the amount of phrases he wants to see in the phrase cloud.

Phrases may be of importance only in a very limited portion of a file. If such phrases are included in the cloud, then they will only be larger in a small percentage of the entire file, and thus not very useful for navigation. However, such phrases could be removed from the cloud when they are less useful, and replaced by other phrases, while still trying to minimize discontinuity in the animation.

In a further embodiment, the cloud visualization is divided into horizontal layers, one on top of the other. The upper layer contains phrases which correspond to broad themes which appear throughout a file, and it may display the same set of phrases throughout the entire visualization of the file. The lower layers contain clouds of phrases which appear in increasingly smaller sections of the file. Thus, the graph of such phrases typically forms a spike, where most of the graph is very low or even zero, and only in one place, there is a high continuous peak. Since the phrase only appears in a limited part of the file, it becomes useless in large portions of the file. The aim is to show the “spiked” phrases only when they are useful. When one spiked phrase has a low value, it is removed from the cloud, and replaced by another phrase which is relevant to the current location in the file.

Sorting the phrases in lower layers is problematic, since when phrases are replaced the new phrase may need to be relocated to a new place in the list of sorted phrases. This can change the positioning of the phrase in the cloud, and thus cause a large appearance of discontinuity in the animation. To maintain smoother animation, the relocation of phrases can be animated smoothly, or, alternatively, the sorting of the phrases can be abandoned, and when a phrase is replaced, the new phrase would be positioned at the same location of the old phrase.

The intended user experience of viewing such a cloud is that the upper layers would track broad themes of the file, and would have very smooth animation—since phrases are not replaced. Middle layers would track themes which correspond to sections in the file. Lower layers would track specific and limited prominent topics. Animation would become more discontinuous in the lower layers due to higher replacement of phrases. Thus, the user should be able to focus on the upper levels to find general topics of interest, and—once these have been located—move the focus to the lower levels to find more specific and detailed topics of interest.

Example Method

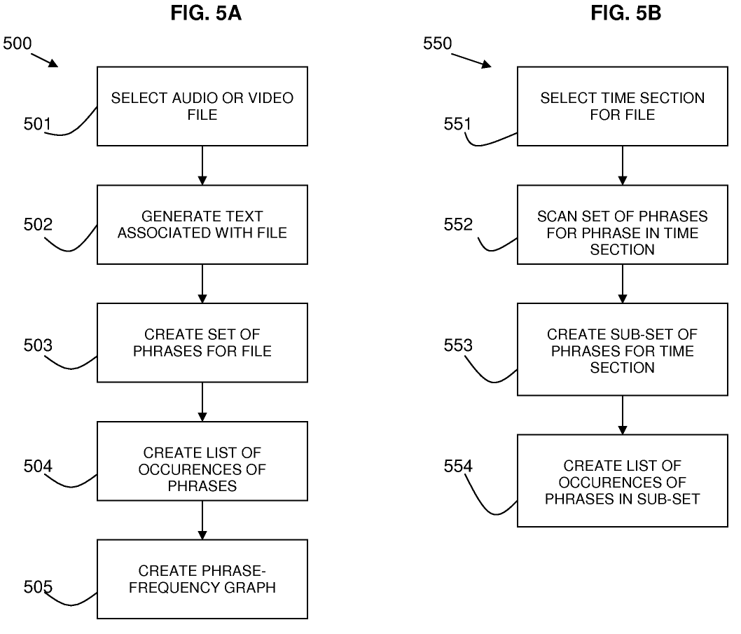

Referring to FIGS. 5A and 5B, flow diagrams 500, 550 of generating a phrase cloud display for an audio or video file are shown.

In FIG. 5A, an audio or video file is selected 501 for navigation using the skimming application. Text associated with the file is generated or read from a pre-generated file 502 with timestamps for the occurrences of the words or phrases or time sections of the file within which the word or phrase is relevant. A set of phrases is created 503 for the file with a list 504 of occurrences with timestamps or time sections. A time-frequency graph is created 505 for the file.

In FIG. 5B, a time section of an audio or video file is selected 551. The set of phrases created at step 503 of FIG. 5A is scanned 552 for occurrences in the time section. A sub-set of phrases occurring in the time section is created 553. The occurrences of the phrase are saved 554 against the sub-set of phrases.

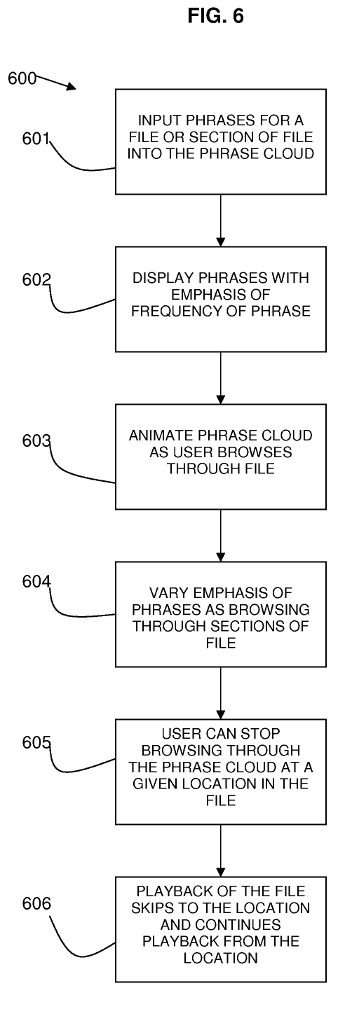

Referring to FIG. 6, a flow diagram 600 shows the operation of the phrase cloud. The phrases for a file or a section of a file are input 601 into the phrase cloud. The phrases are displayed 602 to give emphasis to phrases with a high frequency in a section of the file. The phrase cloud is animated 603 as a user browses through the phrase cloud at a speed determined by the user. The emphasis of phrases varies 604 as the browsing takes place and move through different sections of the file.

A user can stop 605 browsing through the phrase cloud at a given location in the file and the playback of the file will skip 606 to the location and continue playback from the location.

The following are possible solutions for several technical implementation issues.

Defining the Phrase Scoring Function

For a given phrase, the phrase scoring function assigns a value for each section of a file. It is desirable to have a smooth phrase scoring function—if the function is jagged the cloud animation will be jumpy. A phrase scoring function which simply assigns values according to the number of occurrences of phrases in a section is likely to be jagged.

One way to create a smooth function is to set its values such that even if the phrase actually appears several sections away from the current section, the function value will begin to increase, so that the form of highlighting will start. For example, if the highlighting is size, the phrase will be bigger than normal and if the highlighting is color, the color will start to change. The following is an example for such a function.

Let p be a phrase. The aim is to compute the function fₚ(i) which returns a score for phrase p in section i.
Let dfₚ be the document frequency of p.
Let tfₚ(i) be the frequency of phrase p in section i.
Let k be a constant—when calculating the value fₚ(i), sections from i−k up to i+k will be taken into consideration.
Let tfidfₚ(i)=tfₚ(i)/dfₚ

First calculate a function gₚ taking into consideration nearby sections, but giving greater weight to pages nearer to i.

gₚ(i)=Σ_{i-k≦j≦i+k}(tfidfₚ(j)*(k−|j−i|)²)

Let maxgₚ be the maximal value of the function gₚ(i) for all i in the text. Then fₚ(i) is obtained by normalizing gₚ(i):

fₚ(i)=gₚ(i)/maxgₚ

Choosing a List of Phrases for the Cloud

The choice of phrases to appear in the cloud is crucial. The phrases should satisfy several properties: they should be phrases that users might be interested in; and their fₚ(i) value should vary across the file. If the value does not vary then its size will not change in the cloud animation, and this would not help the user to navigate in the file.

Automatically finding good phrases is difficult. This is complicated by the fact that the same topic may be discussed using different synonymous or related words. This may be partially solved by aggregating the functions of the two different phrases, and choosing one to represent them both.

Algorithms for automatically constructing a list of phrases can be taken from several areas of research in computer science. Methods for extracting keywords can be used directly. Methods for text summarization use techniques such as term frequency and document graphs which may be used to construct phrase lists. Alternatively, the automatic text summaries can be used as an input for other algorithms which would extract keywords from the summary. Text segmentation is the task of determining the positions at which topics change in a stream of text—such segmentation can be used as an input for further processing to determine which phrases are most representative of each section.

The alternative is to manually choose the phrases. It is possible for a creator or user of an audio or video file to go through the file and manually choose appropriate phrases to appear in the cloud.

Either of these possibilities can be used; however, another practical way of defining the set of phrases is suggested. This is a phrase choice tool which goes through the text generated for a file, and sorts phrases automatically according to various criteria. However, it may be up to the file creator or user to choose which phrases will eventually appear in the cloud. The tool offers lists of words and phrases sorted according to several criteria, for example:

Frequency in entire file; and variance. For example,

Let p be a phrase,

Let n be the number of sections in the file.

Let mean μₚ=(Σ_{1≦i≦n}fₚ(i))/n

Sample variance s(p)=(Σ_{1≦i≦n}(fₚ(i)−μp)²)/n

The lists can be limited to certain grammatical parts of text, such as verbs or nouns.

The tool may offer the following functionality to the creator or user.
The creator can request a list of phrases to be presented and sorted according to a chosen criterion. The creator can then choose phrases from the list and add them to the list of phrases which is to be included in the cloud. The creator can also sort the phrases he specified to be included in the cloud, since the final user may resize the window and thus not all the phrases would be presented. The phrases which appear first in the sort will have preference in being shown to the user in case the window cannot accommodate all the phrases.
Possible lists of phrases could be: frequent words, frequent verbs, frequent nouns, words with high variance, etc.
The tool should allow the creator to specify which phrases should actually be considered together as a larger phrase.
The tool would allow the animation of the cloud to be shown.
The tool would allow the creator to indicate which phrases are related, or synonymous to a degree that their functions should be combined.

Combining functions can be done as follows. Let Q be a set of related phrases, and let w be a phrase from Q which is chosen to represent all of Q. Then the value of the scoring function for w can be recalculated, for each file section i:

f_{w}(i)=Σ_{q-Q}f_{q}(i)

Layered Embodiment—Choosing Phrases for Each Layer

To animate the layered embodiment, it needs to be decided which phrases will appear in which layers.

By analyzing the function of each phrase, it can be determine in which layer the phrase would be most appropriate. Some possible measures of a phrase are:
The percent of sections in which the function for the phrase is greater than zero. The aim would be to put phrases with larger percentages into higher layers.
The number of non-zero portions. Such a portion is a range of sections where the value of the function is greater than zero inside the portion, and exactly zero in the sections before, and after the portion. The aim would be to put phrases with more portions in higher layers. The rationale is that more portions imply that the phrase may be of interest in more places in the file.

Let m(p) be a function over phrases which uses either one of the measures above, a similar measure, or a combination of them. If the desired number of layers is determined in advance, and it is known which phrases are to be included in the cloud, m(p) can be used to assign phrases to layers.

This could be integrated in the phrase choice tool. The file creator would be able to request the sorting of the phrases into layers by setting thresholds for each layer. For example, the creator could say that the top layer should include only a specific fraction (e.g. 10%) of the phrases—this would sort the phrases such that the top tenth (when sorted by m(p)) of the phrases are placed in the top layer.

Deciding which Phrases to Show for Each File Section, in a Cloud or Layer

There may be a large list of phrases, too large to fit in the allotted space in the user interface. There are two options for animating a cloud (or a layer of a cloud). Either the same set of phrases is displayed for all pages (so we have to choose a smaller set from the large list), or more phrases are presented by allowing the set of phrases to change across pages. For the latter option it needs to be decided:
which of the phrases to show in each section; and
in which location they should appear inside the cloud.

Determination of which Phrases should be Shown for a Section:

It is supposed that a list of phrases is provided for a given layer; however, at each point only some of the phrases will be presented, as space allows. This space may change according to the size of the window. Thus calculating which phrases should appear for each section, should be done just before animating the cloud.

Let S be the set of phrases which are to be used to display a cloud (or layer). Let c be the number of phrases for which there is place for. Thus, the decision of which phrases to show in each section i of the file can be given as a function H(i), whose range is a subset of S, where the subset is of size c. These c phrases will be chosen such that they are maximal according to some measure.

A naive measure to use is simply fₚ(i). However, this may cause much discontinuity in animation. Two phrases may have fₚ values which alternate in peaks. Using the fₚ measure for choosing the phrases may cause these two phrases to repeatedly replace each other in the animation. Instead, it would be preferable to choose one of them only.

The problem with simply using fₚ(i) is that it only considers the local values in section i, and not the surrounding context. One option is to generate a new function, Gp(i), which assigns values according to continuous portion of sections for which the value of fₚ is non zero. These sections can be located, assigned values to, and then for each section, i, in the section, assign Gp(i) to that value. An algorithm for generating the function Gp(i) would be as follows
for all sections i, set Gp(i) to 0
loop over non-zero portions, setting j,k to the start and end sections of the non zero portion, respectively
let val=calculate_measure(j,k)
for m=j to k, Let Gp(i)=val

There are numerous options for the function calculate_measure(j,k), for example: the maximal value of fₚ(i), where j≦i≦k

Σ_{j≦i≦k}: fₚ(i)

j−k—the number of sections in the portion.

Using Gp should provide smoother animation.

Determination of Locations where Phrases Should appear Inside the Cloud:

Initially, the phrases in a cloud could be sorted alphabetically. Moving from one section to the next, a set of phrases may need to be replaced. Each new phrase would take the place of one old phrase which would be omitted.

The disclosed implementation of phrase clouds provides smooth animation, and can be skimmed more quickly than other solutions. Smooth animation is achieved by keeping the phrases in the cloud approximately in the same place and just changing their highlighting such as their sizes and/or colors.

A skimming application alone or as part of a media player application may be provided as a service to a customer over a network.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

The invention can take the form of a computer program product accessible from a computer-usable or computer-readable medium providing program code for use by or in connection with a computer or any instruction execution system. For the purposes of this description, a computer usable or computer readable medium can be any apparatus that can contain, store, communicate, propagate, or transport the program for use by or in connection with the instruction execution system, apparatus or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read only memory (ROM), a rigid magnetic disk and an optical disk. Current examples of optical disks include compact disk read only memory (CD-ROM), compact disk read/write (CD-R/W), and DVD.

Improvements and modifications can be made to the foregoing without departing from the scope of the present invention.

We claim:

1. A method for navigation of a file, comprising:
providing an audio or video file;
generating text associated with the file;
displaying a plurality of phrases from the text for the file;
emphasizing a displayed phrase to indicate the relevance of the phrase in a predefined section of the file; and
animating the display of phrases to show changes in the emphasizing during progression through the file.

2. The method as claimed in claim 1, wherein generating text associated with the file includes one or more of the group of: transcripts of audio content, extraction of text from video content, associating text with the audio or video content, including user tagging of the file.

3. The method as claimed in claim 1, wherein generating text associated with the file includes providing a location of the text in the file by a timestamp.

4. The method as claimed in claim 1, wherein generating text associated with the file includes providing a section of the file to which the text relates by a range of timestamps of occurrence in the file.

5. The method as claimed in claim 1, wherein the relevance of a phrase in a predefined section of the file is determined by a relevance algorithm based on the frequency of occurrence of the phrase.

6. The method as claimed in claim 1, wherein the relevance of the phrase is smoothed over neighbouring sections of the file.

7. The method as claimed in claim 1, including selecting a time location or range in the file activates the animation of the display of phrases from the time location or range.

8. The method as claimed in claim 1, including providing an additional display of the occurrences of a phrase throughout the file, wherein selecting an occurrence of a phrase in the additional display activates the animation of the display of phrases from the occurrence.

9. The method as claimed in claim 1, wherein when a phrase is present in the display of phrases, the phrase is kept in the same position in the display during the animation.

10. The method as claimed in claim 1, wherein phrases are added to and removed from the display during progression through the file, and the method includes minimizing discontinuity of the animation.

11. The method as claimed in claim 1, wherein emphasizing a displayed phrase and animating changes in emphasis include one or more of the group of: emphasizing the phrase in a color and changing the tone or strength of the color; emphasizing the size of the phrase and changing the size; emphasizing a background color of a phrase and changing the tone or strength of the background color; emphasizing a font of the phrase and changing the font type, or amount of bold, italics or underline.

12. The method as claimed in claim 1, wherein emphasizing a displayed phrase includes a graphical indication of an increase or decrease in relevance compared to neighbouring areas of file.

13. The method as claimed in claim 1, wherein the progression through the file enabling animating of the display of phrases to show changes in the emphasis is carried out at a speed determined by the user.

14. The method as claimed in claim 1, wherein stopping progression through the file activates a playback of the file from the current position of the progression.

15. The method as claimed in claim 1, wherein displaying a plurality of phrases representing the content of the text includes displaying the phrases in at least two layers, a first layer including phrases relevant to the entire file, and one or more subsequent layers including phrases relevant to sections of the file.

16. A system for navigation of an audio or a video file, comprising:
a text generation tool associated with the file and extracting phrases from the text;
a user interface including a display of a plurality of phrases representing the content of the text, and including means for progressing though the file to advance the display;
means for emphasizing a displayed phrase to indicate the relevance of the phrase in a predefined section of the file; and
an animator for animating the display of phrases to show changes in the emphasizing during progression through the file.

17. The system as claimed in claim 16, wherein the means for progressing though the file has a variable speed for selection by a user.

18. The system as claimed in claim 16, wherein the user interface further includes a graph showing the phrase occurrences through the file.

19. The system as claimed in claim 16, wherein the display of the phrases consists of at least two layers, a first layer including phrases relevant to the entire file, and one or more subsequent layers including phrases relevant to sections of the file.

20. The system as claimed in claim 15, including means for interacting with a media player application to navigate through an audio or video file played by the media player application according to a selected position in the display of phrases.

21. A computer software product for navigation of a file, the product comprising a computer-readable storage medium, storing a computer in which program comprising computer-executable instructions are stored, which instructions, when read executed by a computer, perform the following steps:
providing an audio or video file;
generating text associated with the file;
displaying a plurality of phrases from the text for the file;
emphasizing a displayed phrase to indicate the relevance of the phrase in a predefined section of the file; and
animating the display of phrases to show changes in the emphasizing during progression through the file.

22. A method of providing a service to a customer over a network, the service comprising:
providing an audio or video file;
generating text associated with the file;
displaying a plurality of phrases from the text for the file;
emphasizing a displayed phrase to indicate the relevance of the phrase in a predefined section of the file; and
animating the display of phrases to show changes in the emphasizing during progression through the file.
